(19) United States
(12) Patent Application Publication
(10) Pub. No.: US 2020/0073652 A1
(43) Pub. Date: Mar. 5, 2020

(54) FIRMWARE UPDATE METHOD AND COMPUTER SYSTEM

(71) Applicant: Wistron Corporation, New Taipei City (TW)

(72) Inventor: Jia-Hui Chen, New Taipei City (TW)

(21) Appl. No.: 16/205,178

(22) Filed: Nov. 29, 2018

(30) Foreign Application Priority Data
Aug. 28, 2018 (TW) 107129928

(51) Int. Cl. G06F 8/65; G06F 9/4401

(52) U.S. Cl. CPC G06F 8/65; G06F 9/4403

(57) ABSTRACT

A firmware update method for a computer system is provided. The computer system includes a current BIOS. The firmware update method includes receiving a firmware update command, writing a new BIOS into a second storage circuit according to the firmware update command and setting a flag indicating a storage location of the new BIOS, performing a reboot process and determining whether the flag has been set during the reboot process, and determining that the flag has been set and utilizing the new BIOS to perform the reboot process according to the flag.

### BACKGROUND OF THE INVENTION

### 1. Field of the Invention

The present invention relates to a firmware update method and a computer system, and more specifically to a firmware update method and a computer system capable of improving stability of system.

### 2. Description of the Prior Art

A basic input/output system (BIOS) plays a very important role in the functioning of a computer system during boot-up. In general, through the BIOS, hardware configurations of all components can be initialized and the computer system can load the operating system successfully during boot-up. BIOS code is usually stored in a storage device in practice. As the computer system provides system power to a center processor, the center processor further accesses and executes the BIOS code stored in the storage device in order to perform a boot process for the computer system.

Since hardware architecture of the computer system updates quickly, the BIOS must be updated (e.g., upgrade or downgrade) constantly for the latest hardware architectures. During a firmware update process, the conventional computer system is usually switched to enter a sleep state (e.g., an S3 sleep state of an advanced configuration and power interface (ACPI)) at first and further loads the current BIOS (i.e. an older version of BIOS) to perform a reboot process. The reboot process must be completed before a new BIOS image file is used to replace the current BIOS image file for firmware update. However, if the hardware configuration of the computer system has changed or been damaged and the current BIOS is still used to perform the reboot process. Under such a situation, since the current BIOS cannot fix hardware configuration error, the reboot process will not be completed, thus resulting in a reboot failure. For example, if the user lifts the center processor away from the motherboard and inserts the center processor into the motherboard again, a real time clock (RTC) device of the computer system will be reset. Under such a situation, a setting error of the RTC device already exists and the current BIOS cannot fix the hardware configuration error. If the current BIOS is used to perform the reboot process, the reboot process will not be completed and thus a reboot failure occurs. As a result, the computer system is unable to complete the firmware update. Therefore, how to solve the above mentioned problems has become an important issue in the field.

### SUMMARY OF THE INVENTION

It is therefore a primary objective of the present invention to provide an electronic system and an audio processing method capable of dynamically adjusting sound field effect in real-time.

According to an embodiment of the present invention, an exemplary firmware update method for a computer system is disclosed. computer system comprises a current basic input/output system (BIOS) stored in a first storage circuit, the exemplary firmware update method comprises receiving a firmware update command; writing a new BIOS into a second storage circuit according to the firmware update command and setting a flag indicating a storage location of the new BIOS; performing a reboot process and determining whether the flag has been set during the reboot process; and determining that the flag has been set and utilizing the new BIOS to perform the reboot process according to the flag.

According to an embodiment of the present invention, an exemplary computer system is disclosed. The exemplary computer system comprises a processing circuit; a first storage circuit, for storing a current basic input/output system (BIOS); a second storage circuit, wherein when the computer system receives a firmware update command, a new BIOS is written into the second storage circuit; a boot loader, for determining whether a fag has been set during a reboot process, the flag indicating a storage location of the new BIOS; wherein when determining that the flag has been set, the processing circuit utilizes the new BIOS to perform the reboot process according to the flag.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the invention.

FIG. 2 is a flow diagram of a procedure for firmware update according to an embodiment of the present invention.

FIG. 3 is a schematic diagram of the storage circuit storing the new BIOS according to an embodiment of the invention.

FIG. 4 a flow diagram of an alternative embodiment of the procedure shown in FIG. 2 according to an embodiment of the present invention

FIG. 5 is a schematic diagram of the memory storing the new BIOS 300 according to an embodiment of the invention.

FIG. 6 is a schematic diagram of the firmware update according to an embodiment of the invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

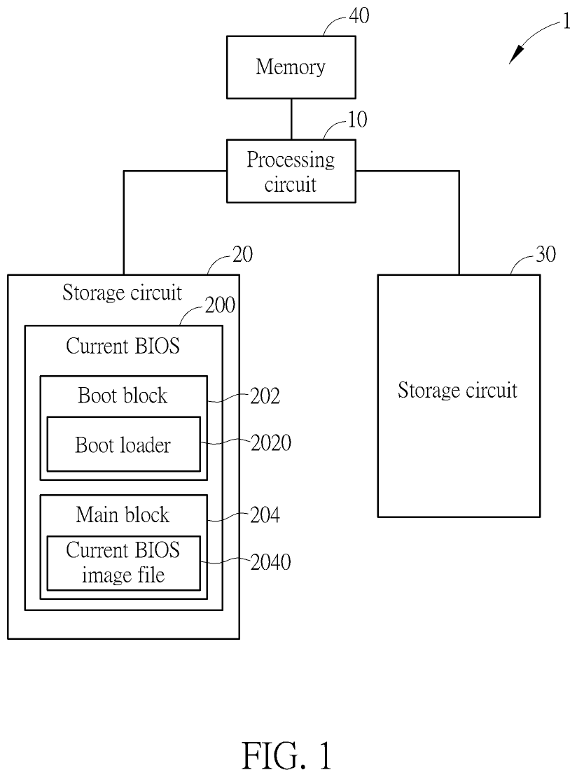

Please refer to FIG. 1, which is a schematic diagram of a computer system 1 according to an embodiment of the invention. The computer system 1 can be notebook or a desktop computer, but not limited thereto. The computer system 1 includes a processing circuit 10, storage circuits 20, 30 and a memory 40. The processing circuit 10 can be a central processing unit (CPU) or a central processor, but not limited thereto. The processing circuit 10 is utilized for controlling operations of the computer system 1 to carry out the functions of the computer system 1. The processing circuit 10 can access data stored in the storage circuits 20, 30 and the memory 40 via a chipset, a keyboard controller or an embedded controller (not shown in figures). The storage circuit 20 is coupled to the processing circuit 10 for storing a current basic input/output system (BIOS) 200. The current BIOS 200 includes a boot block 202 and a main block 204. The boot block 202 includes a boot loader 2020. The main block 204 includes a current BIOS image file 2040. The storage circuits 20 and 30 can be flash read only memories (Flash ROMs), electrically erasable programmable read only memories (EEPROMs), or any other kind of storage devices which can be read and/or written. The memory 40 is coupled to the processing circuit 10 for storing data being accessed and executed by the processing circuit 10. For example, data can be loaded into the memory 40 and the processing circuit 10 accesses the data in the memory 40 for executing related processes.

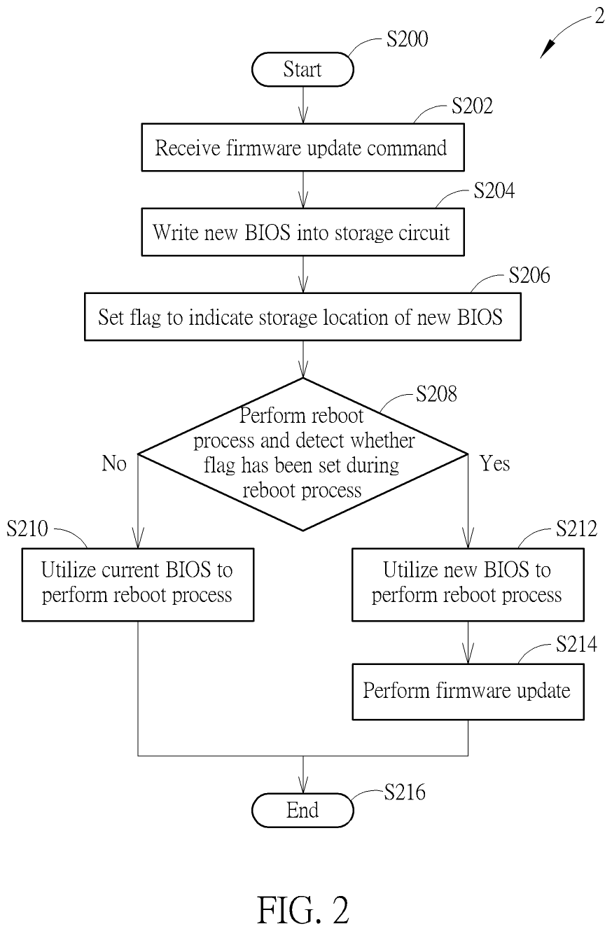

For an illustration of operations of the computer system 1, please refer to FIG. 2. FIG. 2 is a flow diagram of a procedure 2 for firmware update according to an embodiment of the present invention. The flow diagram in FIG. 2 mainly corresponds to the operations on the computer system 1 shown in FIG. 1. The procedure 2 includes the following steps:

Step S200: Start.

Step S202: Receive a firmware update command.

Step S204: Write the new BIOS 300 into the storage circuit 30.

Step S206: Set a flag to indicate the storage location of the new BIOS 300.

Step S208: Perform reboot process and detect whether the flag has been set during the reboot process; if no, go to Step 212; if yes, go to Step 212.

Step S210: Utilize the current BIOS 200 to perform the reboot process.

Step S212: Utilize the new BIOS 300 to perform the reboot process.

Step S214: Perform a firmware update.

Step S216: End.

According to the procedure 2, when a firmware update is required, the computer system 1 is configured to trigger a firmware update command according to a user's input or system setting. For example, when an icon or a button (e.g., a firmware update icon or a firmware update button) in a desktop graphical user interface of an operating system of the computer system 1 is clicked by a user with an input device, a firmware update command is generated accordingly. Therefore, the computer system 1 can detect and receive the firmware update command (Step S202).

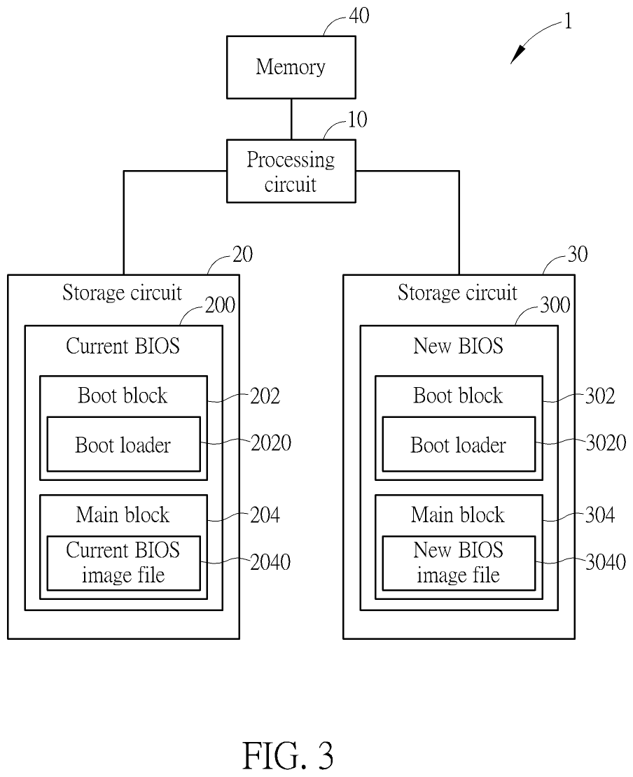

After detecting and receiving the firmware update command, a new BIOS 300 is written into the storage circuit 30 by the computer system. 1 according to the firmware update command (Step S204). Please refer to FIG. 3. FIG. 3 is a schematic diagram of the storage circuit 30 storing the new BIOS 300 according to an embodiment of the invention. As shown in FIG. 3, the new BIOS 300 is written into the storage circuit 30. The new BIOS 300 includes a boot block 302 and a main block 304. The boot block 302 includes a boot loader 3020. In an embodiment, the boot loader 3020 and the boot loader 2020 have similar operations and functions. The main block 304 includes a new BIOS image file 3040. As such, the storage circuit 20 stores the current BIOS 200, and the current BIOS 200 is the current version of BIOS. The storage circuit 30 stores the new BIOS 300, and the new BIOS 300 is a new version of BIOS.

In an embodiment, in Step S204, the computer system 1 can download the new BIOS 300 from a remote server over a network and store the downloaded new BIOS 300 into the storage circuit 30. The computer system 1 can also obtain the new BIOS 300 from an external device via wired or wireless communications.

In Step S206, a flag (e.g., a boot from incoming BIOS (BFIB) flag) is set to indicate a storage location of the new BIOS 300. For example, the flag set in Step S206 is utilized for indicating the storage location of the new BIOS 300. The flag set in Step S206 is utilized for indicating the storage location of the boot loader 3020 of the boot block 302. The flag set in Step S206 is utilized for indicating the storage location of the new BIOS image file 3040 of the main block 304. In addition, the set flag can be stored in the storage circuit 20, the storage circuit 30 or any other storage device. After the flag is set, the computer system 10 is triggered to perform a reboot process.

In an embodiment, a driver of the operating system of the computer system 1 is configured to detect the firmware update command. After detecting and receiving the firmware update command, the driver writes the new BIOS 300 into the storage circuit 30 according to the firmware update command and sets a flag to indicate that the new BIOS 300 is stored in the storage circuit 30. After that, the computer system 1 is triggered to perform a reboot process. As a result, the Steps of S202, S204 and S206 are implemented accordingly.

After triggering the reboot process of the computer system 1 in Step S206, the computer system 1 performs a reboot process (Step S208). During the reboot process, the boot loader 2020 detects and determines whether a flag has been set. When determining that the flag has been set, the boot loader 2020 loads the new BIOS image file 3040 stored in the storage circuit 30 according to the detected flag in response to the set flag, such that the processing circuit 10 utilizes the new BIOS image file 3040 to perform the reboot process. In other words, the computer system 1 utilizes the new BIOS 300 to perform the reboot process when determining that the flag has been set (Step S212). The conventional computer system uses the current BIOS to perform a reboot process. If the hardware configuration of the computer system has changed or been damaged and the current BIOS cannot fix hardware configuration error, the reboot process will not be completed, thus resulting in the boot failure. In comparison, the embodiment of the invention utilizes the new BIOS to perform the reboot process and is able to fix the hardware configuration error during reboot so as to successfully complete the reboot process, and thus effectively improving the stability of the computer system and providing a more convenient operation for the user.

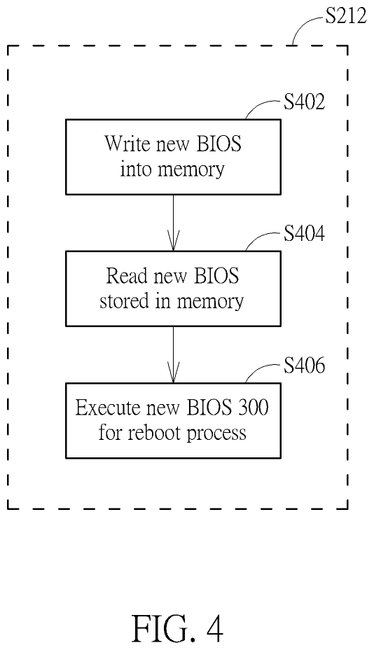

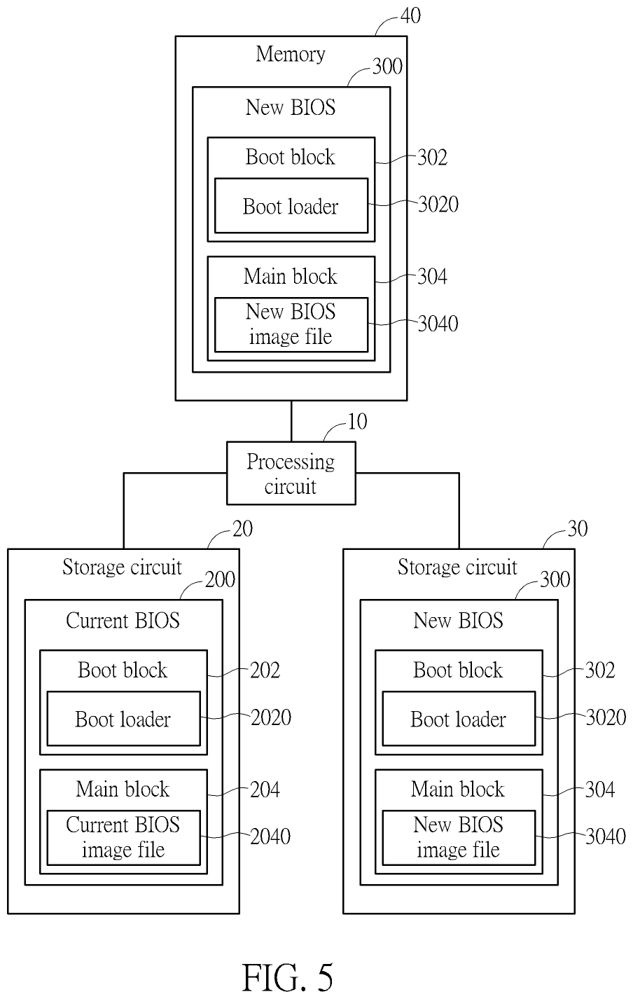

Further description associated with the operation of utilizing the new BIOS 300 to perform the reboot process in Step S212 is provided as follows. Please refer to FIG. 4. In Step S402, the new BIOS 300 is read from the storage circuit 30 and the read new BIOS 300 is written into the memory 40. For example, please refer to FIG. 5. FIG. 5 is a schematic diagram of the memory 40 storing the new BIOS 300 according to an embodiment of the invention. As shown in FIG. 5, the new BIOS 300 is written into the memory 40. Further, in Step S404, the processing circuit 10 reads the new BIOS 300 stored in the memory 40. For example, the processing circuit 10 is configured to read the new BIOS image file 3040 of the main block 304 of the new BIOS 300 stored in the memory 40 by executing a jump command. In Step S406, the processing circuit 10 executes the new BIOS image file 3040 for performing the reboot process.

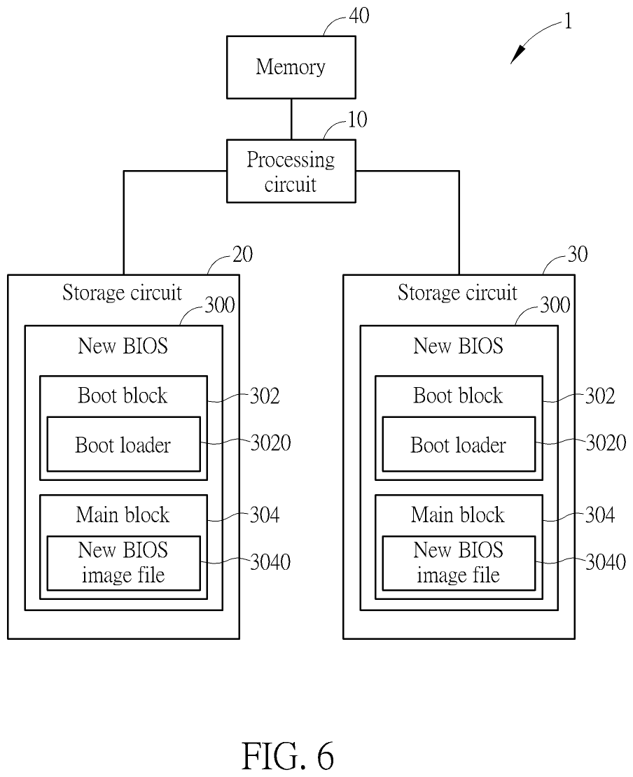

In Step S214, the current BIOS 200 stored in the storage circuit 20 is replaced with the new BIOS 300 for firmware update. For example, the current BIOS 200 stored in the storage circuit 20 is removed or deleted from the storage circuit 20. The BIOS 300 stored in the storage circuit 30 is copied from the storage circuit 30 to the storage circuit 20. That is, the BIOS 300 stored in the storage circuit 30 is copied and the copied BIOS 300 is written into the storage circuit 20 to replace the current BIOS for firmware update. For example, please refer to FIG. 6. FIG. 6 is a schematic diagram of the firmware update according to an embodiment of the invention. As shown in FIG. 6, the storage circuit 20 stores the new BIOS 300 after the firmware update. In addition, operations of the firmware update can designed in accordance with practical system requirements. For example, in Step S214, the current BIOS image file 2040 of the main block 204 of the current BIOS 200 stored in the storage circuit 20 can be replaced with the new BIOS image file 3040 of the main block 304 of the new BIOS 300. The boot loader 2020 of the boot block 202 stored in the storage circuit 20 can be reserved without update. In addition, the boot loader 2020 of the current BIOS 200 may be independently stored in other storage device without being included in the current BIOS 200.

On the other hand, in Step S208, when determining that the flag has not been set, the boot loader 2020 loads the current BIOS image file 2040 stored in the storage circuit 20, such that the processing circuit 10 utilizes the current BIOS image file 2040 to perform the reboot process. In other words, the computer system 1 utilizes the current BIOS 200 to perform the reboot process when determining that the flag has not been set (Step S210). In such a situation, the flag may not be set correctly. Since the computer system 1 uses the current BIOS to perform a reboot process. If the hardware configuration of the computer system has changed or been damaged and the current BIOS cannot fix hardware configuration error, the reboot process will not be completed, thus resulting in the boot failure.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system, or combination thereof. Examples of hardware can include analog, digital and mixed circuits known as microcircuit, microchip, or silicon chip. Examples of the electronic system may include a system on chip (SoC), system in package (SiP), a computer on module (CoM) and the computer system 1. Any of the abovementioned procedures and examples above may be compiled into program codes or instructions that are stored in the storage circuits 20 and 30, the memory 40, a computer-readable storage medium. The computer-readable storage medium may include read-only memory (ROM), flash memory, random access memory (RAM), hard disk, floppy diskette, or CD-ROM/DVD-ROM/BD-ROM, but not limited thereto. The processing circuit 10 may read and execute the program codes or the instructions stored in the computer-readable storage medium for realizing the abovementioned functions. For example, the boot loader 2020 includes program codes of the boot loader. The program codes of the boot loader can be loaded into the memory 40. The processing circuit 10 may read and execute the program codes of the boot loader stored in the memory 40 for realizing the functions of the boot loader 2020.

In summary, during the firmware update process, the embodiment of the invention utilizes the new BIOS to perform the reboot process and is able to fix the hardware configuration error while rebooting so as to successfully complete the reboot process, and thus effectively improving the stability of the computer system and providing a more convenient operation for the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A firmware update method for a computer system comprising a current basic input/output system (BIOS) stored in a first storage circuit, the firmware update method comprising:
receiving a firmware update command;
writing a new BIOS into a second storage circuit according to the firmware update command and setting a flag indicating a storage location of the new BIOS;
performing a reboot process and determining whether the flag has been set during the reboot process; and
determining that the flag has been set and utilizing the new BIOS to perform the reboot process according to the flag.

2. The firmware update method of claim 1, wherein the step of determining that the flag has been set and utilizing the new BIOS to perform the reboot process according to the flag comprises:
writing the new BIOS into a memory of the computer system;
reading the new BIOS stored in the memory; and
executing the new BIOS to perform the reboot process.

3. The firmware update method of claim 1, further comprising:
after performing the reboot process, obtaining the new BIOS from the second storage circuit and writing the obtained new BIOS into the first storage circuit to replace the current BIOS.

4. The firmware update method of claim 1, further comprising:
determining that the flag has not been set and utilizing the current BIOS to perform the reboot process.

5. A computer system comprising:
a processing circuit;
a first storage circuit, for storing a current basic input/output system (BIOS);
a second storage circuit, wherein when the computer system receives a firmware update command, a new BIOS is written into the second storage circuit;
a boot loader, for determining whether a fag has been set during a reboot process, the flag indicating a storage location of the new BIOS;
wherein when determining that the flag has been set, the processing circuit utilizes the new BIOS to perform the reboot process according to the flag.

6. The computer system of claim 5, wherein after the new BIOS is written into a memory of the computer system, the processing circuit reads and executes the new BIOS stored in the memory to perform the reboot process.

7. The computer system of claim 5, wherein after performing the reboot process, the processing circuit obtains the new BIOS from the second storage circuit and writes the obtained new BIOS into the first storage circuit to replace the current BIOS.

8. The computer system of claim 5, wherein when determining that the flag has not been set, the processing circuit utilizes the current BIOS to perform the reboot process.
